(19) United States
(12) Patent Application Publication
(10) Pub. No.: US 2015/0241870 A1
(43) Pub. Date: Aug. 27, 2015

(54) PORTABLE COMPUTER AND ASSOCIATED METHOD OF MODELING A SEALANT SPRAYING PROCESS

(71) Applicant: The Boeing Company, Chicago, IL (US)

(72) Inventor: Chin H. Toh, Orange, CA (US)

(73) Assignee: The Boeing Company, Chicago, IL (US)

(21) Appl. No.: 14/190,572

(22) Filed: Feb. 26, 2014

(51) Int. Cl. G05B 19/4097; B05B 12/08; B05B 12/10; B05B 12/02

(52) U.S. Cl. CPC G05B 19/4097; B05B 12/02; B05B 12/085; B05B 12/10; G05B 2219/45013; G05B 2219/42155

(57) ABSTRACT

A portable computer, a method and a computer-readable storage medium are provided to facilitate modeling of a sealant spraying process. In the context of a method, a portable computer is provided that is configured to receive a plurality of parameters related to the sealant spraying process and to determine instructions regarding the sealant application. The method also includes receiving, with the portable computer at a location proximate a workpiece to be subjected to a spray sealant, the plurality of parameters relating to the sealant spraying process. The method further includes determining, with the portable computer at the location proximate the workpiece, instructions regarding the sealant application based upon the plurality of parameters relating to this sealant spraying process. The method additionally includes displaying the instructions regarding the sealant application.

### TECHNOLOGICAL FIELD

An example embodiment of the present disclosure relates generally to a sealant spraying process and, more particularly, to a portable computer, a method and a computer-readable storage medium for modeling the sealant spraying process.

### BACKGROUND

During the assembly and manufacture of various products, a sealant may be applied to seal the surfaces and/or to protect the product from adverse conditions. For example, during the assembly of an aircraft or an aircraft subassembly, sealant may be applied to various components. For example, sealant may be applied to the joints between components and to fasteners installed in the components. The sealant may seal the faying surfaces and/or otherwise protect the components from subsequent exposure to adverse environmental conditions.

The sealant may be manually applied by dispensing sealant from a sealant cartridge. The manual application of sealant may be time consuming in instances in which the area to be coated with sealant is substantial. Additionally, the manual application of sealant may sometimes produce inconsistent seals which may, in turn, necessitate rework sooner than may be desired. As such, automated techniques for applying sealant have been developed.

The sealant advantageously has a predetermined thickness and distribution in order to most effectively seal the underlying workpiece. In order to determine the spraying conditions, such as the speed, pressure and distance, that are necessary in order to deposit a coating of sealant having the desired thickness and distribution, a plurality of different tests may be conducted in which the sealant is deposited with different spraying conditions and then evaluated. However, this trial-and-error process may be relatively time intensive and it may sometimes be necessary to repeat the trial-and-error process in instances in which there are changes, such as changes in the sealant, changes in the workpiece or the like.

### BRIEF SUMMARY

A portable computer, a method and a computer-readable storage medium are provided in accordance with an example embodiment of the present disclosure in order to facilitate modeling of a sealant spraying process. By utilizing a portable computer, the sealant spraying process may be modeled proximate the workpiece to be sealed. In addition, by utilizing a physics-based sealant spray modeling process, the portable computer, the method and the computer-readable storage medium may model the sealant spraying process based upon a plurality of parameters that define the sealant spraying process such that instructions regarding the manner in which the sealant should be applied may be determined in an efficient and accurate manner. As such, the portable computer, the method and the computer-readable storage medium may effectively determine the manner in which a sealant spraying process should be conducted in order to deposit sealant of a predefined thickness and distribution without undergoing the extensive trial-and-error testing.

In one embodiment, a method of modeling a sealant spraying process is provided that includes providing a portable computer configured to receive a plurality of parameters related to the sealant spraying process and to determine instructions regarding the sealant application. The method of this embodiment also includes receiving, with the portable computer at a location proximate a workpiece to be subjected to a spray sealant, the plurality of parameters relating to the sealant spraying process. The method of this embodiment further includes determining, with the portable computer at the location proximate the workpiece, instructions regarding the sealant application based upon the plurality of parameters relating to this sealant spraying process. The method of this embodiment additionally includes displaying the instructions regarding the sealant application.

The method of one embodiment may determine the instructions regarding the sealant application by determining at least one of a deposit size, a deposit thickness or a temperature-time profile for the sealant spraying process. The method of one embodiment may receive the plurality of parameters by receiving at least one of sealant parameters or sprayer parameters, such as at least one of a supplied pressure, a sprayer dimension, a nozzle dimension, a spraying distance, an internal friction condition, a piston diameter, a sealant density or a sealant viscosity. The method of an example embodiment may also include determining whether the sealant deposited in accordance with the instructions regarding the sealant application satisfies a predefined criteria, and, if not, iteratively repeating the steps of receiving the plurality of parameters and determining the instructions regarding the sealant application. In this embodiment, the parameters that are received during a subsequent iteration are different from the parameters during a prior iteration. Although the method may model the sealant spraying process in conjunction with a variety of workpieces, the workpiece of one embodiment may include an assembly of the aircraft components.

In another embodiment, a portable computer is provided that is configured to model a sealant spraying process. The portable computer includes a processor configured to receive, at a location proximate a workpiece to be subjected to a spray of sealant, a plurality of parameters relating to the sealant spraying process. The processor of this embodiment is also configured to determine, at the location proximate the workpiece, instructions regarding a sealant application based upon the plurality of parameters relating to the sealant spraying process. The processor of this embodiment is further configured to display the instructions regarding the sealant application.

The processor of one embodiment may be configured to determine the instructions regarding the sealant application by determining at least one of a deposit size, a deposit thickness or a temperature-profile for the sealant spraying process. The processor of one embodiment may be configured to receive the plurality of parameters by receiving at least one of sealant parameters or sprayer parameters, such as at least one of a supplied pressure, a sprayer dimension, a nozzle dimension, a spraying distance, an internal friction condition, a piston diameter, a sealant density or a sealant viscosity. The processor of an example embodiment may be further configured to determine whether the sealant deposited in accordance with the instructions regarding the sealant application satisfies the predefined criteria and, if not, to iteratively repeat the steps of receiving the plurality of parameters and determining the instructions regarding the sealant application. In this embodiment, the parameters that are received during a subsequent iteration differ from the parameters received during a prior iteration. In one embodiment, the workpiece to which the sealant is applied may include an assembly of aircraft components.

In a further embodiment, a non-transitory computer-readable storage medium is provided for modeling a sealant spraying process. The computer-readable storage medium has computer-readable program code portions stored therein that in response to execution by a processor cause a portable computer to receive, with the portable computer at a location proximate a workpiece to be subjected to a spray of sealant, a plurality of parameters relating to the sealant spraying process. The computer-readable program code portions also cause the portable computer to determine, with the portable computer at the location proximate the workpiece, instructions regarding a sealant application based upon the plurality of parameters relating to the sealant spraying process. The computer-readable program code portions are further configured to cause the portable computer to display the instructions regarding the sealant application.

The computer-readable program code portions may cause the portable computer to determine the instructions regarding the sealant application by determining at least one of a deposit size, a deposit thickness or a temperature-time profile for the sealant spraying process. The computer-readable program code portions of an example embodiment may cause the portable computer to receive the plurality of parameters by receiving at least one of sealant parameters or sprayer parameters, such as at least one of a supplied pressure, a sprayer dimension, a nozzle dimension, a spraying distance, an internal friction condition, a piston diameter, a sealant density or a sealant viscosity. The computer-readable program code portions of one embodiment, in response to execution by the processor, may further cause the portable computer to determine whether the sealant deposited in accordance with the instructions regarding the sealant application satisfies a predefined criteria and, if not, to iteratively repeat the steps by receiving the plurality of parameters and determining the instructions regarding the sealant application. In this embodiment, the parameters that are received during a subsequent iteration differ from the parameters received during a prior iteration.

### BRIEF DESCRIPTION

Having thus described aspects of the present disclosure in general terms, reference will now be made to the accompanying drawings, which are not necessarily drawn to scale, and wherein:

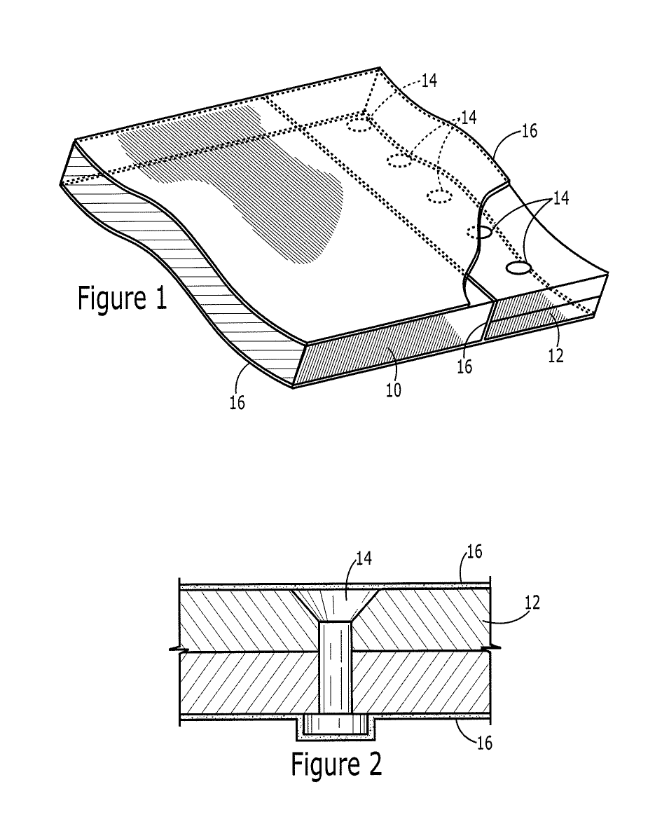

FIG. 1 is a perspective view illustrating a sealant applied to a workpiece;

FIG. 2 is a side view illustrating sealant applied to workpiece that includes a fastener;

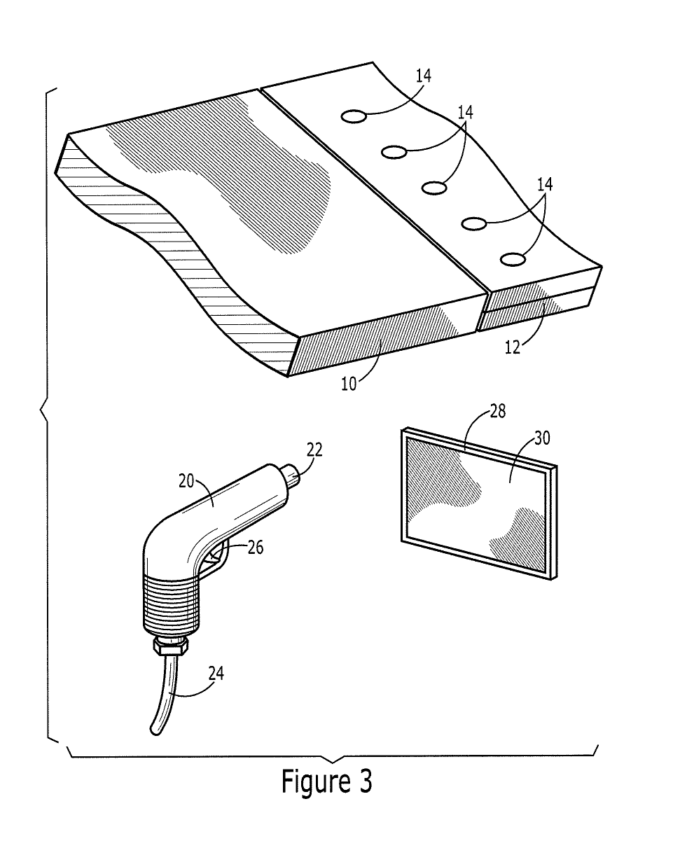

FIG. 3 illustrates a system in accordance with an example embodiment of the present disclosure that includes a sprayer for applying sealant to a workpiece and a portable computer for modeling the sealant spraying process;

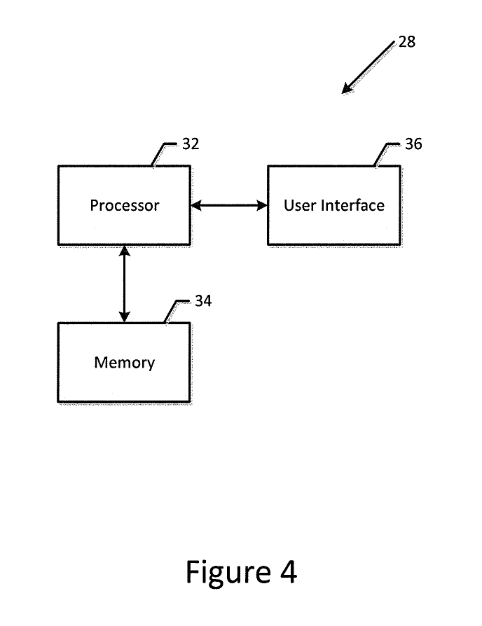

FIG. 4 is a block diagram of a portable computer that may be specifically configured in accordance with an example embodiment of the present disclosure;

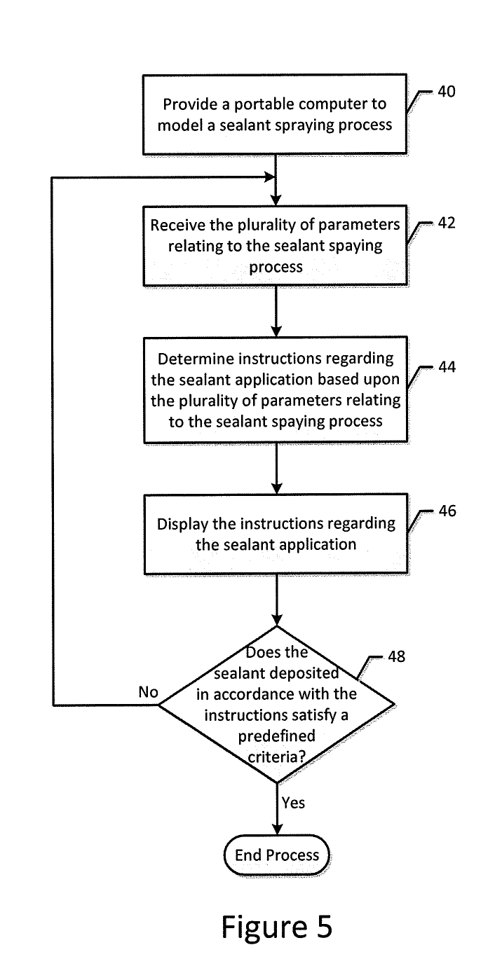

FIG. 5 is a flowchart illustrating the operations performed in accordance with an example embodiment of the present disclosure;

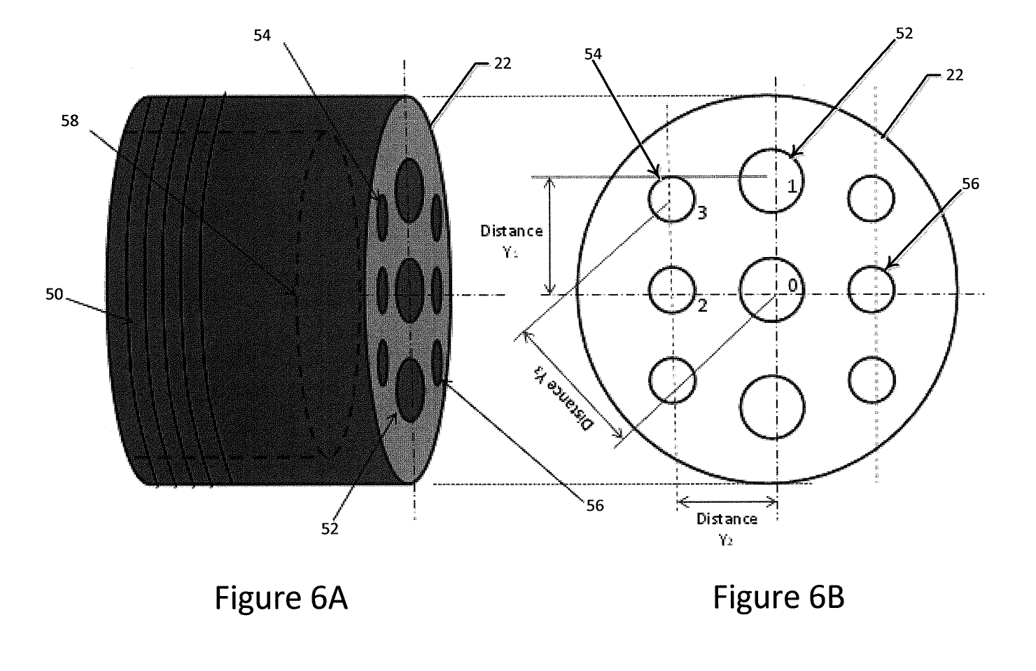

FIG. 6a is the perspective view of a piston nozzle of a sprayer for spraying sealant upon a workpiece;

FIG. 6b is a front view of the piston nozzle of FIG. 6a illustrating the plurality of openings defined therethrough;

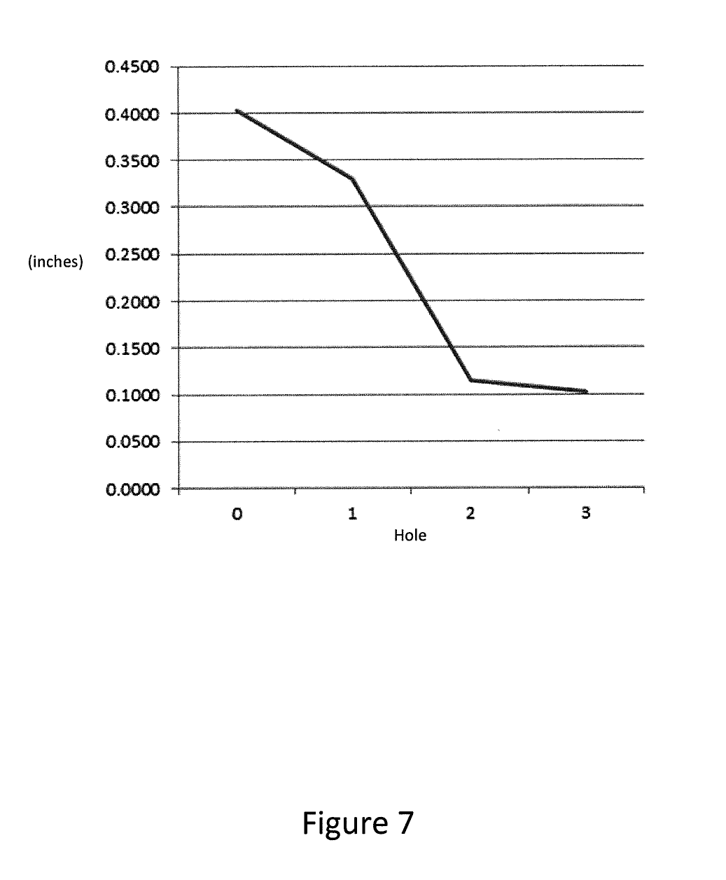

FIG. 7 is a graphical representation of the sealant thickness as delivered through the holes of the piston nozzle of FIGS. 6a and 6b designated 0, 1, 2 and 3; and

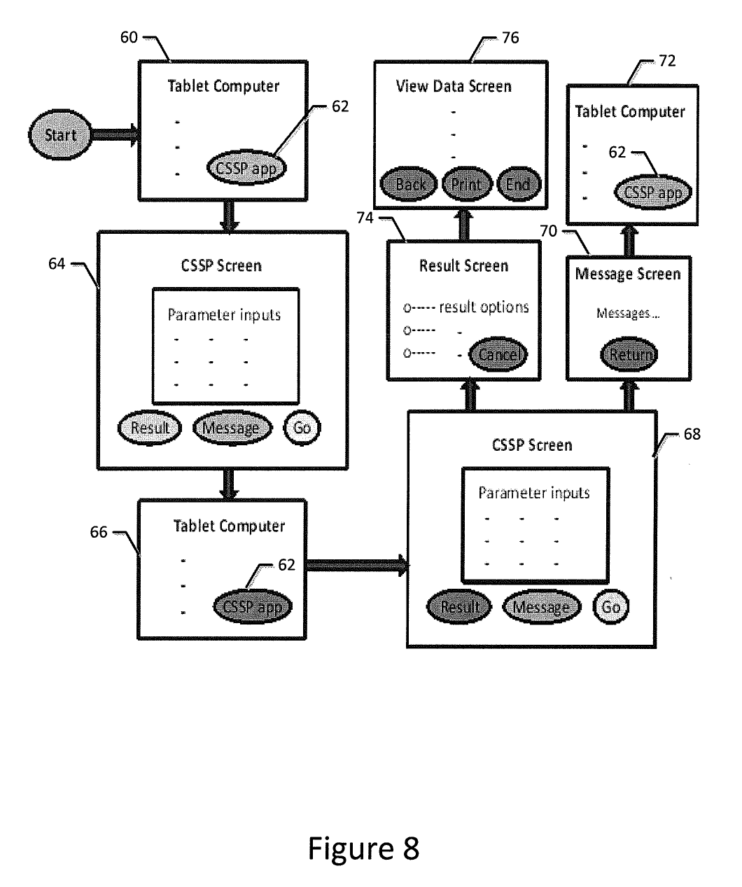

FIG. 8 is a flowchart illustrating interaction with the computer-readable storage medium for modeling a sealant spraying process and the various information displayed thereby in accordance with an example embodiment of the present disclosure.

### DETAILED DESCRIPTION

The present disclosure now will be described more fully hereinafter with reference to the accompanying drawings, in which some, but not all aspects are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

A portable computer, method and computer-readable storage medium are provided in accordance with example embodiments of the present disclosure in order to model a sealant spraying process. The sealant spraying process may be utilized to apply a coating of sealant of a wide variety of workpieces. For example, the sealant spraying process may be configured to apply a coating of sealant to a workpiece comprised of a plurality of aircraft components, such as an aircraft or an aircraft subassembly.

One example of a workpiece to which sealant may be applied is shown in FIG. 1. In this example, the workpiece includes two components, 10, 12 positioned proximate one another such that a joint is defined between the two components. As also shown in FIG. 1, one of the components comprises a pair of subcomponents that may be joined by a plurality of fasteners 14, such as a plurality of rivets. In the illustrated embodiment, the head of the fasteners are flush with the surface of the component, while the button of the fasteners, opposite the head, protrudes beyond the surface of the component as shown in FIG. 2. However, the head and/or button of the fasteners may either protrude above or be recessed relative to the surface of the component in other embodiments. In order to protect the components and the fasteners from adverse environmental conditions that may be experienced once the workpiece has been placed in service, at least a portion of the workpiece may be coated with a sealant as shown by the coating 16.

Various types of sealants may be utilized including, for example, high-viscosity sealants, such as polysulfide sealants, such as those provided by Advanced Chemistry & Technology, that are commonly utilized in conjunction with aircraft production. These high-viscosity sealants are relatively sticky and exhibit non-Newtonian behavior. Although the entire surface of the workpiece may be coated with a sealant as shown in FIG. 1, only selected portions of the workpiece may be coated with a sealant in other embodiments, such as those portions of the workpiece proximate a joint and/or the faying surfaces as these portions of the workpiece may otherwise deteriorate more rapidly upon exposure to adverse environmental conditions.

In regards to the FIG. 1, the surfaces of the components 10, 12 may be coated to the sealant 16 and the sealant may also at least partially or completely fill the joint between the components. Additionally, the sealant may overlie the fasteners 14 so as to protect the workpiece and, in particular, the joint between the components and the fasteners from deterioration when subsequently subjected to adverse environmental conditions. As shown in FIG. 2, the sealant may be applied to the opposed surfaces of the components. In this regard, the sealant may overlie both the head and the button of the fastener so as to protect the fastener and the faying surfaces.

By implementing the sealant spraying process upon a portable computer, such as a tablet computer, the modeling may be performed at a location proximate the workpiece to be subjected to the spray of sealant, such as in the same room as and, more typically, adjacent to the workpiece to be subjected to the spray of sealant. As shown in FIG. 3, for example, the workpiece to be subjected to the spray of sealant may be positioned at a designated location within a facility. As noted above, various types of workpieces may be coated with the sealant, but the pair of components 10, 12 depicted in FIG. 1 are also shown in FIG. 3 by way of an example. In order to subsequently deliver the spray of sealant, a sprayer 20 may also be at the same location. The sprayer may be configured in a variety of manners, but is depicted for purposes of illustration but not of limitation as a spray gun. The spray gun includes a housing including a nozzle 22 as will be described below through which the sealant is directed onto the workpiece. The spray gun of the illustrated embodiment may also be fluidly connected, such as via a hose 24, to a source of sealant. Additionally, the sprayer may include an actuator, such as a trigger 26, that may be manually actuated in order to controllably dispense the sealant. While a manually-actuated sprayer is depicted in FIG. 3, an automated sprayer may alternatively be utilized.

The sprayer 20 of one embodiment is described by U.S. patent application Ser. No. 13/919,318, filed Jun. 17, 2013, the contents of which are incorporated herein in their entirety. As described therein, the sprayer may include a housing defining a chamber for receiving the sealant, such as from a source of sealant, and a heating system for increasing the temperature and corresponding decreasing the viscosity of the sealant to facilitate its spraying upon a workpiece. The inner surface of the housing of one embodiment may be formed a friction-reducing material, such as polytetrafluoroethylene (PTFE), a nanostructured ceramic material, a nanostructured non-stick material or the like. The sprayer may also include a dispensing device including, for example, a piston for moving the sealant in the chamber toward the exit from the chamber, such as for spraying through the nozzle 22. The piston of one embodiment may be controllably moved by compressed air from an initial position to an actuated position so as to discharge sealant through nozzle. The dispensing device of one embodiment may also include a spring for returning the piston to its initial position once the flow of compressed air has been halted. The nozzle may include or otherwise be associated with a nozzle screen. The nozzle screen defines a plurality of openings and serves to increase the pressure of the sealant dispensed from the nozzle, such that the sealant is dispensed in a spraying manner.

As also shown in FIG. 3, a portable computer 28, such as a tablet computer, may be co-located with the workpiece and the sprayer 20. The portable computer is configured to model the sealant spraying process and to provide instructions regarding the application of the sealant. Thus, the portable computer includes a display 30 upon which the instructions may be presented. By modeling the sealant spraying process and providing instructions regarding the sealant application at the same location at which the workpiece is to be subjected to the spray of sealant, the portable computer and associated method may provide the instructions regarding the sealant application in a quicker and more efficient manner in comparison to techniques that might otherwise rely upon a fixed computer located remotely from the workpiece, such as in another facility. This improvement in efficiency is especially notable in instances in which the modeling is performed in an iterative manner with the parameters that govern the sealant spraying process being modified and the instructions regarding sealant application being correspondingly modified since the repeated modeling of the sealant spraying process may be performed by the portable computer at the same location at which the workpiece is located without having to repeatedly travel to a remote location in order to model the sealant spraying process prior to returning to the location of the workpiece that is to be subjected to the spray of sealant.

The portable computer 28 may be embodied in various manners. For example, the portable computer may be embodied as a tablet computer or other type of mobile computer. Regardless of the manner in which the portable computer is embodied, the portable computer is configured to be readily carried and operated by the user without requiring a wired connection for power, communications or the like. Additionally, the portable computer may, in one embodiment, be embodied as shown in FIG. 4 so as to include or is associated and in communication with processing circuitry that is configurable to perform actions in accordance with one or more example embodiments disclosed herein. In this regard, the processing circuitry may be configured to perform and/or control performance of one or more functionalities of the portable computer in accordance with various example embodiments, and thus may provide means for performing functionalities of the portable computer. The processing circuitry may be configured to perform data processing, application execution and/or other processing and management services according to one or more example embodiments.

In some example embodiments, the processing circuitry may include a processor 32 and, in some embodiments, such as that illustrated in FIG. 4, may further include memory 34. The processing circuitry may be in communication with or otherwise control a user interface 36, such as a display 30, e.g., a touchscreen, a keyboard and/or other input/output mechanisms. As such, the processing circuitry may be embodied as an integrated circuit chip configured (e.g., with hardware, software or a combination of hardware and software) to perform operations described herein.

The processor 32 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In some example embodiments, the processor may be configured to execute instructions stored in the memory 34 or otherwise accessible to the processor. As such, whether configured by hardware or by a combination of hardware and software, the processor may represent an entity (e.g., physically embodied in circuitry—in the form of processing circuitry) capable of performing operations according to embodiments of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 34 may include one or more non-transitory memory devices such as, for example, volatile and/or non-volatile memory that may be either fixed or removable. In this regard, the memory may comprise a non-transitory computer-readable storage medium. The memory may be configured to store information, data, applications, instructions and/or the like for enabling the computing device to carry out various functions in accordance with one or more example embodiments. For example, the memory may be configured to buffer input data for processing by the processor 32. Additionally or alternatively, the memory may be configured to store instructions for execution by the processor. Among the contents of the memory, applications may be stored for execution by the processor in order to carry out the functionality associated with each respective application. In some cases, the memory may be in communication with one or more of the processor or the user interface 36 via a bus or buses for passing information among components of the portable computer 28.

Referring now to FIG. 5, the operations performed by the portable computer 28 in accordance with one embodiment of the present disclosure are illustrated. As shown in block 40 of FIG. 5, the portable computer may be provided to model a sealant spraying process. As noted above, the portable computer may be a tablet computer or other type of mobile computer that may be readily transportable by a user and may function in various locations without a wired connection for power, communications or the like. In this regard, the user may utilize the portable computer at the same location at which the workpiece is to be sprayed with the sealant.

As shown in block 42 of FIG. 5, the portable computer 28, such as the processor 32, the user interface 36 or the like, may be configured to receive a plurality of parameters relating to the sealant spraying process. In this regard, the portable computer may be disposed at a location proximate the workpiece to be subjected to the spray of sealant, such as by being co-located with the workpiece, at the time at which the portable computer receives the plurality of parameters relating to the sealant spraying process. The portable computer, such as the processor, the user interface or the like, may be configured to receive a variety of sealant parameters, that is, parameters relating to the sealant with which the workpiece will be sprayed, and/or sprayer parameters, that is, parameters relating to the sprayer 20 that will deliver the sealant to the workpiece. An example of the sealant parameters includes the sealant density and viscosity and examples of the sprayer parameters include the supplied pressure, sprayer dimensions, nozzle dimensions, spraying distance, e.g., distance from the sprayer nozzle to the workpiece, internal friction conditions and the piston diameter. By way of further illustration, an example is provided below of the instructions that are determined by the portable computer to govern the sealant application and a plurality of parameters relating to the sealant spraying process that are provided by the user to the portable computer are noted in the example.

Based upon the plurality of parameters relating to the sealant spraying process, the portable computer 28, such as the processor 32 or the like, is configured to determine instructions regarding the sealant application. See block 44 of FIG. 5. In this regard, the portable computer may be configured to determine the instructions regarding the sealant application while the portable computer is at the location proximate the workpiece, such as by being co-located with the workpiece. As illustrated by the subsequent example, the portable computer, such as the processor, may be configured to determine a variety of instructions regarding the sealant application. However, examples of the instructions that may be determined by the portable computer regarding the sealant application include the deposit size that indicates the dimensions of the deposit, such as the diameter of a circular deposit, and/or the deposit thickness defining the thickness of the coating 16 of sealant to be deposited upon the workpiece. Another example of the instructions that may be determined and, in turn, displayed by the portable computer includes the velocity of sealant exiting the spraying nozzle. Yet another example of the instructions that may be determined by the portable computer includes a real-time temperature-time profile for the sealant that provides information to the user regarding the current temperature of the sealant to maintain the proper viscosity for the duration of spraying process.

As shown in block 46, the portable computer 28, such as the processor 32, the user interface 36 or the like, may be configured to display the instructions regarding the sealant application, such as upon display 30. As such, a user may refer to the instructions in order to properly configure the sealant spraying process and to thereafter affect the sealant spraying process. Once the sealant has been sprayed on to the workpiece in accordance with the instructions that were determined by the portable computer, the method may determine whether the sealant deposited in accordance with the instructions regarding the sealant application satisfies the predefined criteria as shown in block 48 of FIG. 5. Various types of predefined criteria may be utilized to evaluate the sealant deposited in accordance with the instructions. For example, the predefined criteria may define a minimum thickness or a range of acceptable thicknesses of the sealant. In an instance in which the sealant deposited in accordance with the instructions satisfies the predefined criteria, the sealant spraying process may terminate.

However, in an instance in which the sealant deposited in accordance with the instructions regarding the sealant application fails to satisfy the predefined criteria, the portable computer 28, such as the processor 32 or the like, may be configured to iteratively repeat the steps of receiving the plurality of parameters and determining the instructions regarding the sealant application as shown in blocks 42 and 44 of FIG. 5. In this instance, the parameters that are received during the subsequent iteration may differ from the parameters received during prior iterations such that the instructions that are determined regarding the sealant application may also correspondingly differ from those determined during the prior iteration. As such, in an instance in which the sealant deposited upon the workpiece does not satisfy the predefined criteria, the user may modify the parameters relating to the sealant spraying process, such as by altering the supplied pressure, nozzle dimensions, spraying distance and/or sealant viscosity prior to repeating the process as shown in FIG. 5. This iterative approach may be repeated until the coating of sealant satisfies the predefined criteria.

By way of example, the instructions regarding the sealant application may be determined by the portable computer 28, such as the processor 32, based upon parameters supplied by the user regarding the supplied pressure Pᵢ and the inner cylinder diameter, also known as the piston diameter Dₐ of the sprayer 20. In this regard, the portable computer, such as the processor, may determine the initial spraying force Fᵢ as follows:

Fᵢ=PᵢAᵢ=Pᵢ{πDₐ²/4} (1)

wherein Aᵢ is the cross-sectional area of the cylinder. The portable computer, such as the processor, may also determine the spring resistant force Fₛ as follows:

Fₛ=Kₛδₛ (2)

wherein δₛ is the stroke distance of the piston of the sprayer and Kₛ is the spring constant of the spring included within the sprayer. In this regard, the spring constant Kₛ may be defined as follows:

Kₛ=Gd⁴/{8nD³} (3)

In the foregoing equation, G is the spring material shear modulus, d is the wire diameter, n is the number of coils and D is the mean coil diameter. As such, the portable computer 28, such as the processor 32, may determine the effective spring force F_{eff} as follows:

F_{eff}=Fᵢ−Fₛ (4)

For each stroke of the piston of the sprayer 20, the portable computer 28, such as the processor 32, may determine the supplied sealant volume increment ΔV as follows:

ΔV=δₛAᵢ (5)

and the stroke sealant flow rate Q as follows:

Q=ΔV/Δt (6)

wherein Δt is the stroke time of the piston of the sprayer 20. The portable computer 28, such as the processor 32, may also be configured to determine the sealant mass per stroke ΔM as follows:

ΔM=ρΔV (7)

wherein ρ is the sealant density. As noted above, the sealant density is a sealant parameter that may have been previously provided by the user.

For a sprayer 20 having a Teflon-coated flowpath having a coefficient of friction of μ_{f}, the cylinder wall contact static friction force F_{w} may be defined as follows to be the product of the contact area, the contact pressure and the friction coefficient:

F_{w}=2π(Dₐ/2)δₛ(F_{eff}/Aᵢ)μ_{f} (8)

As such, the portable computer 28, such as the processor 32, may determine the initial flow pressure P_{f} as follows:

P_{f}=(F_{eff}−F_{w})/Aᵢ (9)

In this example, the sealant is assumed to behave as a Newtonian fluid with constant viscosity at a specific temperature since the sealant will also be assumed to be heated to a temperature at which its intended property does not change, to reduce its viscosity and to maintain a laminar flow during the spraying process. The sealant is further assumed to be incompressible with no volume changes during the spraying process at a specific temperature. That is, the density of the sealant remains constant during the spraying operation. With the above assumptions, the portable computer 28, such as the processor 32, may determine the Reynolds number Rₑ for laminar sealant flow as follows:

Rₑ=64/μ_{f} (10)

For Newtonian fluid flow, the portable computer 28, such as the processor 32, may determine the shearing force Fₙ along the center of the cylinder defined by the sprayer 20 to be defined as follows:

Fₙ=μAₚU/Y (11)

wherein μ is a dynamic viscosity, Aₚ is the area of the horizontal shear plane, U is the central flow velocity and Y is the distance from the wall. In a sprayer in which Aₚ=Dₐ δₛ, the maximum flow velocity at the center is U and Y=Dₐ/2, such that Equation 11 relating to the shearing force Fₙ can be rearranged for the central flow velocity U as follows:

U=Fₙ/(2μδₛ) (12)

Since Fₙ≈F_{eff}−F_{w} for the initial flow of the sealant, the maximum initial sealant flow velocity at the center V, may be determined by the portable computer 28, such as the processor 32, as follows:

Vᵢ=(F_{eff}−F_{w})/(2μδₛ) (13)

For the sealant to move from its initial position to the nozzle exit, the portable computer 28, such as the processor 32, may determine the pressure drop along the path of travel P_{d} as follows:

P_{d}=μ_{f}(Lₐ/Dₐ)(ρ/2)Vᵢ² (14)

wherein Lₐ is the length of the flow path. The portable computer 28, such as the processor 32, may also be configured to determine the net force applied on the sealant at the nozzle screen Fₙₑₜ as follows:

Fₙₑₜ=F_{eff}−F_{w}−P_{d}Aᵢ (15)

In this regard, the net pressure on the nozzle screen may be determined by the portable computer 28, such as the processor 32, as follows:

Pₙₑₜ=Fₙₑₜ/Aₙₛ (16)

wherein Aₙₛ is the screen area.

The portable computer 28, such as the processor 32, may also determine the pressure Pₕ for each hole in the screen as follows:

Pₕ=fₐPₙₑₜ/Nₕ (17)

wherein fₐ is the fraction of holes defined as the sum of hole areas divided by the total screen area, and Nₕ is the number of holes. The portable computer 28, such as the processor 32, may also be computed to determine the force on each hole of the screen Fₕ as follows:

Fₕ=fₐFₙₑₜ/Nₕ (18)

By neglecting the elevation difference, the portable computer 28, such as the processor 32, may determine the maximum sealant exit velocity at the nozzle center Vₑₓₜ from the Bernoulli equation as follows:

Vₑₓₜ=√{2(P_{f}−Pₕ)/ρ+Vᵢ²} (19)

The portable computer 28, such as the processor 32, may then determine the sealant exit velocities of the different hole locations by proportionality based upon the distance of the other hole locations from the center of the nozzle 22. From the energy balance of kinetic energy and the work done by the exit force, the portable computer 28, such as the processor 32, may be configured to determine the maximum spray distance dₛ as follows:

dₛ=½MₛVₑₓₜ²/Fₙ (20)

wherein Mₛ=ΔM/Nₕ as the deposited sealant mass from the screen hole as assumed to be circular. The portable computer 28, such as the processor 32, may determine the thickness of the sealant as the product of the individual flow rate and the average deposited time divided by the deposited circular area.

The portable computer 28, such as the processor 32, may also estimate the sealant supply pump power as follows:

Pump power=ρQWp/η (22)

wherein the pump head Wp=½ Vf²+gHf+(sum of pressure losses)/ρ and η is the pump efficiency. In this example, Vf is the exit velocity at the delivery point, g is gravity and Hf is the final delivery height. To perform the spraying modeling of the foregoing example, the user will have input the sprayer dimension, the piston spring variables, the friction coefficient, the pump variables, the nozzle dimensions, the sealant viscosity and density, the supplied pressure and the spraying distance. The portable computer 28 will, in turn, determine and display outputs including one or more of the spray velocity, the deposited sealant size, the deposited sealant thickness and other information that may be of interest to the user pertaining to above formulation in Equations 1 to 22, for example. A real-time temperature-time profile for the sealant may also be determined and displayed regarding the current temperature of the sealant to maintain the proper viscosity for the duration of spraying process.

By way of example, a sprayer 20 may include a piston nozzle 22 through which the sealant is delivered to the workpiece. Although the sprayer may include various types of piston nozzles, one example of the piston nozzle is shown in FIGS. 6A and 6B. As shown in FIG. 6A, the piston nozzle may be connected, such as by being threadably connected by threads 50, to the sprayer housing. The piston nozzle may define an internal cavity 58 and a plurality of openings 52, 54, 56 through the front face of the piston nozzle that open into the internal cylindrical cavity. As such, sealant may be forced through the internal cavity and, in turn, through the openings defined by the piston nozzle, such as by movement of a piston through the sprayer housing.

The piston nozzle 22 may define a variety of openings including openings of various sizes and various arrangements of openings. In the illustrated embodiment, however, three larger openings 52 are positioned along a centerline of the piston nozzle with first and second sets 54, 56 of three smaller openings equally positioned on opposite sides of the three larger openings. As shown in FIG. 6B, the smaller openings may be offset from the larger openings by distance Y₂ as measured center to center. In addition, the three larger openings may be separated from one another by distance Y₁ and the central most opening may be separated from the upper and lower smaller openings by distance Y₃.

With a piston nozzle 22 of the type shown in FIGS. 6A and 6B and relative to the openings defined as 0, 1, 2 and 3 in FIG. 6B, the portable computer 28, such as the processor 32, may determine the thickness of one layer of sealant deposited in four seconds by a sprayer 20 that includes the piston nozzle as shown in FIG. 7. In this regard, the thickness of the sealant delivered by the opening designated 0 is the thickest at about 0.4 inches and thickness of the sealant delivered via the opening designated 1 is somewhat thinner at about 0.33 inches. The thickness of the sealant delivered via the openings designated 2 and 3 are thinner, such as about 0.11 for the sealant delivered via the opening designated 2 and about 0.1 for the sealant delivered via the opening designated 3. In this example, the user may determine from the computed thicknesses if they are the intended sealant thickness distribution for that specific location. Otherwise, the hole pattern and/or sizes will be modified or a different nozzle may be used to deposit the sealant at that particular location. The spraying distance and pressure may also be adjusted to fine-tune the desired deposit thickness and size. As the sprayer may be moved over the course of time, the thickness of the sealant deposited upon the workpiece may be relatively even as the sealant will have contributions from the sealant delivered via each of several different openings of the piston nozzle. This example shows the influences of nozzle hole size and location on the deposited sealant thicknesses.

As described above, the modeling of the sealant spraying process with a portable computer 28 may be performed at a location proximate the workpiece to be subjected to the spray of sealant, such as in the same room as the workpiece to be subjected to the spray of sealant. As such, the spray modeling process may permit instructions including parameters for the sealant application to be provided in a more timely manner, particularly in instances in which the modeling is performed iteratively.

The portable computer 28 may be configured in a variety of manners, but the portable computer of one embodiment may have a number of different states that the portable computer may enter during an execution sequence based upon input by the user. In this regard and as shown in FIG. 8, the portable computer may initially have a home screen 60 that includes an icon or other indicia 62 indicative of the computational sealant spraying process (CSSP) application. Upon selection of this icon or other indicia indicative of the computational sealant spraying process application, the portable computer may present a screen that solicits the plurality of parameters for the sealant spraying process from the user. See the CSSP Screen of state 64. Following entry of the parameters, the user may instruct the portable computer to execute the computational sealant spraying process application to determine the instructions to govern the sealant application, such as by selecting the go button.

While the portable computer 28 is determining the instructions to govern the sealant application in response to the parameters for the sealant spraying process entered by the user, the portable computer may return to the home screen or may otherwise permit other applications to be executed in the foreground and may permit the user to interact with those other applications in state 66. Subsequently, the user may again select the icon or other indicia 62 associated with the computational sealant spraying process application in order to return to the computational sealant spraying process application. In response to the selection by the user to return to the computational sealant spraying process application, the portable computer may again display the screen that presents the parameters that have been entered by the user. See the CSSP Screen of state 68. In instances in which errors have occurred during the process of determining the instructions to govern the sealant application, the user may select an icon or other indicia associated with messages in order to cause the portable computer to display the error or other messages that had been generated. See the Message Screen of state 70. In response to viewing the error messages, the user may, in turn, cause the portable computer to return to the home screen or to a screen associated with another applications as shown by state 72, such as by actuation of the return button.

Alternatively, the user viewing the CSSP Screen of state 68 may elect to view the results including the instructions for the sealant application by selecting, for example, the result button or icon. In response, the portable computer may cause the display to present the instructions for the sealant application. See the Result Screen of state 74. The user may obtain additional detail including data underlying the instructions including plotting and tabulation features as shown at state 76. The execution sequence supported by the portable computer may be very flexible as the user may advance to subsequent screens or return to prior screens by the selection of appropriate buttons, such as the back button. In addition, the information presented upon the display 30 of the portable computer 28 may be printed, such as by user selection of the print button. Further, the computational sealant spraying process application may be terminated by user selection of the end button. As such, the portable computer, method and computer program product permit a sealant spray process to be modeled accurately and in an efficient manner, such as while co-located with the workpiece to be subjected to the spray of sealant.

As described above, FIGS. 5 and 8 illustrate flowcharts of a system, method, and computer program product according to example embodiments of the present disclosure. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 34 of a portable computer 28 and executed by processing circuitry, such as a processor 32, of the portable computer. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the present disclosure. In one embodiment, a suitably configured processor 32 may provide all or a portion of the elements of the present disclosure. In another embodiment, all or a portion of the elements of the present disclosure may be configured by and operate under control of a computer program product. The computer program product for performing the methods of embodiments of the present disclosure includes a computer-readable storage medium, such as the non-volatile storage medium, and computer-readable program code portions, such as a series of computer instructions, embodied in the computer-readable storage medium.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A method of modeling a sealant spraying process, the method comprising:
receiving, with a portable computer at a location proximate a workpiece to be subjected to a spray of sealant, a plurality of parameters relating to the sealant spraying process;
determining, with the portable computer at the location proximate the workpiece, instructions regarding sealant application onto the workpiece based upon the plurality of parameters relating to the sealant spraying process; and
displaying the instructions regarding the sealant application.

2. A method according to claim 1 wherein determining the instructions regarding the sealant application comprises determining at least one of a deposit size or a deposit thickness.

3. A method according to claim 1 wherein determining the instructions regarding the sealant application comprises determining a temperature-time profile for the sealant spraying process.

4. A method according to claim 1 wherein receiving the plurality of parameters comprises receiving at least one of sealant parameters or sprayer parameters.

5. A method according to claim 4 wherein receiving at least one of sealant parameters or sprayer parameters comprises receiving at least one of a supplied pressure, a sprayer dimension, a nozzle dimension, a spraying distance, an internal friction condition, a piston diameter, a sealant density or a sealant viscosity.

6. A method according to claim 1 further comprising:
determining whether the sealant deposited in accordance with the instructions regarding the sealant application satisfies a predefined criteria; and
in an instance in which the sealant deposited in accordance with the instructions regarding the sealant application fails to satisfy the predefined criteria, iteratively repeating the steps of receiving the plurality of parameters and determining the instructions regarding the sealant application, wherein the parameters that are received differ from the parameters received during a prior iteration.

7. A method according to claim 1 wherein the workpiece comprises an assembly of aircraft components.

8. A portable computer configured to model a sealant spraying process, the portable computer comprising a processor configured to:
receive, at a location proximate a workpiece to be subjected to a spray of sealant, a plurality of parameters relating to the sealant spraying process;
determine, at the location proximate the workpiece, instructions regarding a sealant application based upon the plurality of parameters relating to the sealant spraying process; and
display the instructions regarding the sealant application.

9. A portable computer according to claim 8 wherein the processor is configured to determine the instructions regarding the sealant application by determining at least one of a deposit size or a deposit thickness.

10. A portable computer according to claim 8 wherein the processor is configured to determine the instructions regarding the sealant application by determining a temperature-time profile for the sealant spraying process.

11. A portable computer according to claim 8 wherein the processor is configured to receive the plurality of parameters by receiving at least one of sealant parameters or sprayer parameters.

12. A portable computer according to claim 11 wherein the processor is configured to receive at least one of sealant parameters or sprayer parameters by receiving at least one of a supplied pressure, a sprayer dimension, a nozzle dimension, a spraying distance, an internal friction condition, a piston diameter, a sealant density or a sealant viscosity.

13. A portable computer according to claim 8 wherein the processor is further configured to:
determine whether the sealant deposited in accordance with the instructions regarding the sealant application satisfies a predefined criteria; and
in an instance in which the sealant deposited in accordance with the instructions regarding the sealant application fails to satisfy the predefined criteria, iteratively repeat the steps of receiving the plurality of parameters and determining the instructions regarding the sealant application, wherein the parameters that are received differ from the parameters received during a prior iteration.

14. A portable computer according to claim 8 wherein the workpiece comprises an assembly of aircraft components.

15. A non-transitory computer-readable storage medium for modeling a sealant spraying process, the computer-readable storage medium having computer-readable program code portions stored therein that in response to execution by a processor cause an portable computer to:
receive, with the portable computer at a location proximate a workpiece to be subjected to a spray of sealant, a plurality of parameters relating to the sealant spraying process;
determine, with the portable computer at the location proximate the workpiece, instructions regarding a sealant application based upon the plurality of parameters relating to the sealant spraying process; and
display the instructions regarding the sealant application.

16. A computer-readable storage medium according to claim 15 wherein determining the instructions regarding the sealant application comprises determining at least one of a deposit size or a deposit thickness.

17. A computer-readable storage medium according to claim 15 wherein determining the instructions regarding the sealant application comprises determining a temperature-time profile for the sealant spraying process.

18. A computer-readable storage medium according to claim 15 wherein receiving the plurality of parameters comprises receiving at least one of sealant parameters or sprayer parameters.

19. A computer-readable storage medium according to claim 18 wherein receiving at least one of sealant parameters or sprayer parameters comprises receiving at least one of a supplied pressure, a sprayer dimension, a nozzle dimension, a spraying distance, an internal friction condition, a piston diameter, a sealant density or a sealant viscosity.

20. A computer-readable storage medium according to claim 15 wherein the computer-readable program code portions, in response to execution by the processor, further cause the portable computer to:
determine whether the sealant deposited in accordance with the instructions regarding the sealant application satisfies a predefined criteria; and
in an instance in which the sealant deposited in accordance with the instructions regarding the sealant application fails to satisfy the predefined criteria, iteratively repeat the steps of receiving the plurality of parameters and determining the instructions regarding the sealant application, wherein the parameters that are received differ from the parameters received during a prior iteration.
